(19) United States
(12) Patent Application Publication
(10) Pub. No.: US 2014/0118410 A1
(43) Pub. Date: May 1, 2014

(54) ORGANIC LIGHT EMITTING DIODE DISPLAY AND DRIVING METHOD THEREOF

(71) Applicant: SAMSUNG DISPLAY CO., LTD., Yongin-City (KR)

(72) Inventor: Jae-Young OH, Yongin-City (KR)

(73) Assignee: Samsung Display Co., Ltd., Yongin-City (KR)

(21) Appl. No.: 13/761,022

(22) Filed: Feb. 6, 2013

(30) Foreign Application Priority Data
Oct. 29, 2012 (KR) 10-2012-0120643

(51) Int. Cl. G09G 3/32

(52) U.S. Cl. CPC G09G 3/3208
USPC 345/690

(57) ABSTRACT

An organic light emitting diode (OLED) display device and a driving method thereof which compensates for hysteresis of a driving transistor is disclosed. In one aspect, an OLED display device includes a pixel unit; a scan driver that supplies a scan signal to the scan lines; a data driver that supplies a data signal to the data lines; a data compensator that extracts a hysteresis compensation value by comparing current and previous data, and outputs compensation data using the hysteresis compensation value and a luminance/color coordinate compensation value stored in a luminance correction process of a panel. Furthermore, it includes a timing controller that supplies a control signal to the scan driver, the data driver and the data compensator, and provides the data driver with the compensation data supplied from the data compensator.

### CROSS REFERENCE TO RELATED APPLICATIONS

This application claims priority to and the benefit of Korean Patent Application No. 10-2012-0120643, filed on Oct. 29, 2012, in the Korean Intellectual Property Office, the entire content of which is incorporated herein by reference.

### BACKGROUND

1. Field

This application relates to an organic light emitting diode (OLED) display device and a driving method thereof, which can effectively compensate for hysteresis of a driving transistor.

2. Description of the Related Technology

Recently, various types of flat panel display devices have been developed which are capable of reducing the weight and volume as compared to a cathode ray tubes display. These flat panel display devices include liquid crystal displays, field emission displays, plasma display panels, OLED display devices, and the like.

The OLED display device displays images using OLEDs that emit light through recombination of electrons and holes. The OLED display device has a fast response speed and is driven with low power consumption.

The OLED display device has a plurality of pixels arranged in a matrix formed at the intersections of a plurality of scan lines and a plurality of data lines. Each of the pixels includes an OLED and a driving transistor for controlling the amount of driving current flowing in the OLED. The pixel emits light with a luminance in response to a data signal and corresponding to the driving current supplied from the driving transistor to the OLED.

However, the driving current corresponding to the current data voltage does not flow through the driving transistor due to hysteresis of the driving transistor, and therefore, the grayscale level of the current data is not normally displayed. For example, in a case where the pixel displays black throughout a few frames and then displays white, the characteristic curve of the driving transistor is shifted, as an off-voltage is continuously applied to the driving transistor during the black display period. Therefore, an initial target luminance is not sufficiently expressed during the white display period. Accordingly, in order to emit light at target grayscale levels, it is required to predicting whether hysteresis of the driving transistor is generated, and/or the degree of the hysteresis by evaluating previous and current data and then compensating for the hysteresis.

In the OLED display device, a process tolerance of the driving transistor, etc. easily occurs in a panel, and therefore, it may be difficult to express light with the target luminance by simply compensating for only the hysteresis of the driving transistor using the previous and current data. If the same hysteresis is compensated with respect to all panels without considering the process tolerance of the driving transistor, the hysteresis of the driving transistor may be excessively or deficiently compensated as the characteristic curve of the driving transistor is seriously shifted due to the process tolerance of the driving transistor. Therefore, the improvement of screen flickering or shadow effect may be reduced. Accordingly, it is required to propose a plan for more effectively compensating for the hysteresis of the driving transistor by reflecting the process tolerance of the driving transistor in the panel together with the hysteresis of the driving transistor.

### SUMMARY

In one aspect, the organic light emitting diode display device disclosed herein comprises a pixel unit having a plurality of pixels positioned at the intersections of scan lines and data lines; a scan driver configured to supply a scan signal to the scan lines; a data driver configured to supply a data signal to the data lines; a data compensator configured to determine a hysteresis compensation value by comparing a present and a previous data signal, and to output a compensation data value using the hysteresis compensation value and a luminance/color coordinate compensation value; and a timing controller configured to supply a control signal to the scan driver, the data driver, and the data compensator, and to control providing the data driver with the compensation data value supplied from the data compensator.

In some embodiments, the data compensator is configured to calculate a data compensation value using the hysteresis compensation value and the luminance/color coordinate compensation value, and configured to outputs a compensation data signal by performing an operation on the current data signal using the data compensation value.

In some embodiments, the data compensator comprises a storage unit configured to store the previous data signal; a lookup table in which a plurality of hysteresis compensation values corresponding to potential differences between the current and previous data signals are stored; a compensation value calculator configured to determine the hysteresis compensation value from the lookup table which corresponds to the difference between the current and previous data signals, and configured to calculate a data compensation value using the hysteresis compensation value and the luminance/color coordinate compensation value; and an operator configured to output the compensation data signal by performing an operation on the current data signal using the data compensation value.

In some embodiments, the compensation value calculator includes at least one of a subtractor configured to calculate the difference between the current and previous data signals, and an adder configured to add the hysteresis compensation value and the luminance/color coordinate compensation value.

In some embodiments, the compensation value calculator is configured to apply a positive offset value to the extracted hysteresis compensation value when the luminance/color coordinate compensation value is within a positive offset range based on a reference value, and configured to apply a negative offset value to the extracted hysteresis compensation value when the luminance/color coordinate compensation value is within a negative offset range based on the reference value.

In some embodiments, the operator is an adder configured to add the current data signal and the data compensation value.

In another aspect, a method of driving an organic light emitting diode display device, described herein comprises storing a previous data signal; comparing the previous data signal with a current data signal and determining a hysteresis compensation value corresponding to the compared result; calculating a data compensation value using the hysteresis compensation value and a luminance/color coordinate compensation value; generating and outputting a compensation data signal obtained by changing the current data signal using the data compensation value; and generating a data signal corresponding to the compensation data signal and supplying the data signal to pixels.

In some embodiments, determining the hysteresis compensation value comprises calculating a difference between the previous and current data signals; and extracting a hysteresis compensation value from a lookup table in which a plurality of hysteresis compensation values are stored, wherein the hysteresis compensation values correspond potential differences between the present and previous data signals.

In some embodiments, calculating the data compensation value, comprises adding the hysteresis compensation value and the luminance/color coordinate compensation value.

In some embodiments, generating the compensation data signal comprises adding the data compensation value and the current data signal.

In some embodiments, calculating the data compensation value comprises applying a positive offset value to the extracted hysteresis compensation value when the luminance/color coordinate compensation value is within a positive offset range based on a reference value, and applying a negative offset value to the extracted hysteresis compensation value when the luminance/color coordinate compensation value is within a negative offset range based on the reference value.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 depicts an embodiment of an OLED display device.

FIG. 2 depicts an embodiment of the data compensator shown in FIG. 1.

FIG. 3 is a flowchart illustrating an embodiment of a method of calculating a final data compensation value by applying a luminance/color coordinate correction value to a hysteresis compensation value lookup table.

### DETAILED DESCRIPTION OF CERTAIN INVENTIVE ASPECTS

Hereinafter, certain exemplary embodiments will be described with reference to the accompanying drawings. Here, when a first element is described as being coupled to a second element, the first element may be not only directly coupled to the second element but may also be indirectly coupled to the second element via a third element. Further, some of the elements that are not essential to the complete understanding of the invention are omitted for clarity. Also, like reference numerals refer to like elements throughout.

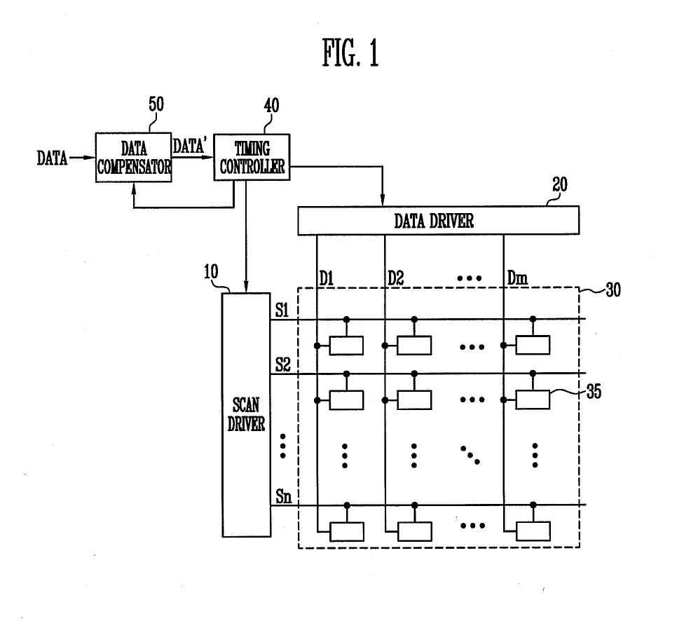

FIG. 1 depicts an embodiment of an OLED display device.

Referring to FIG. 1, the OLED display device according to this embodiment includes a scan driver 10, a data driver 20, a pixel unit 30, a timing controller 40 and a data compensator 50.

The scan driver 10 generates a scan signal, corresponding to a control signal such as a clock signal supplied from the timing controller 40, and supplies the generated scan signal to scan lines S1 to Sn. If the scan signal is supplied to the scan lines 51 to Sn, pixels 35 are selected for each horizontal line.

The data driver 20 generates a data signal, corresponding to the control signal and data, supplied from the timing controller 40, and supplies the generated data signal to data lines D1 to Dm. In some embodiments, the data driver 20 receives a compensation data signal, herein referred to as “compensation data DATA′,” which has been changed so that hysteresis and a process tolerance of the panel transistors can be compensated through the timing controller 40. DATA′

The pixel unit 30 includes a plurality of pixels 35 positioned at the intersections the scan lines S1 to Sn and the data lines D1 to Dm. The pixel unit 30 displays an image corresponding to the data signal supplied by the data lines D1 to Dm.

The timing controller 40 controls operations of the scan driver 10, the data driver 20 and the data compensator 50 while supplying a control signal such as a clock signal to the scan driver 10, the data driver 20 and the data compensator 50. In addition, the timing controller 40 provides the data driver 20 with the compensation data DATA′ supplied from the data compensator 50. Then, the data driver 20 generates a data signal corresponding to the compensation data DATA′.

The data compensator 50 extracts a hysteresis compensation value by comparing a current data signal, herein referred to as “current data DATA” and the previous data. In addition, the data compensator 50 calculates a final data compensation value by using the hysteresis compensation value with a luminance/color coordinate compensation value previously stored in a driving IC, in a luminance correction process. The data compensator 50 changes the current data DATA by applying the calculated data compensation value to the current data DATA and then outputs the changed current data DATA as compensation data DATA′. The compensation data DATA′ output from the data compensator 50 is supplied to the data driver 20 via the timing controller 40.

Here, the hysteresis compensation value may be set to a value corresponding to the difference between the current data DATA and the previous data. For example, as the difference between the current data DATA and the previous data is large, the degree of the hysteresis is large, and thus a larger compensation value may be set.

The luminance/color coordinate correction value is a value specified and stored for each module. For example, the luminance/color coordinate correction value is obtained by detecting luminance and color coordinate characteristics for each panel display in the luminance correction process of the OLED display device during manufacturing and testing. In this case, the luminance and color coordinate characteristics of the panel mainly result from a process tolerance of the panel, such as a threshold voltage of a driving transistor or mobility variation. Therefore, the process tolerance of the panel is reflected in the luminance/color coordinate correction value. Thus, if the compensation data DATA′ is generated by applying the luminance/color coordinate value, the hysteresis of the driving transistor can be more effectively compensated by reflecting the process tolerance of the display panel.

As described above, the hysteresis of the driving transistor is compensated by comparing the current and previous data signals, and the compensation data DATA′ is generated by applying the luminance/color coordinate compensation value together with the hysteresis compensation value. Accordingly, the compensation of the hysteresis of the driving transistor can be optimized by reflecting the process tolerance of the panel together with the hysteresis of the driving transistor.

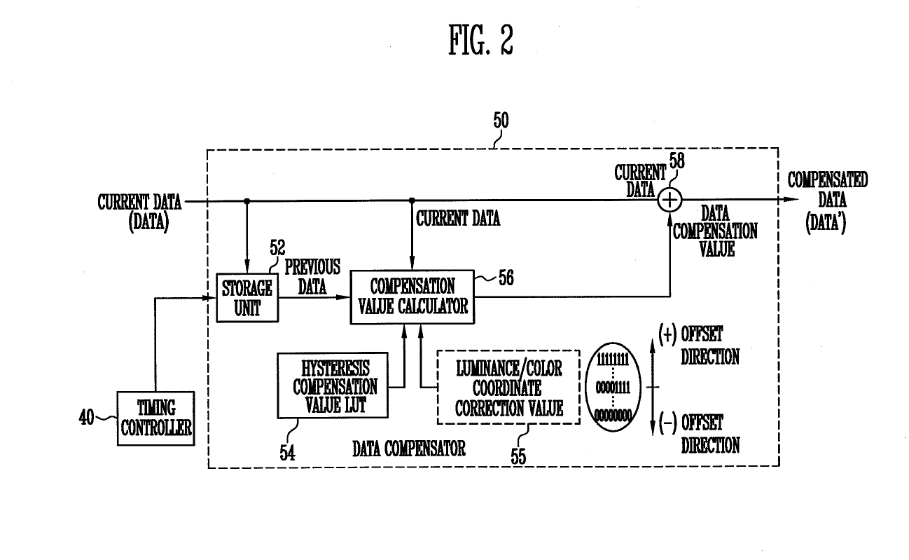

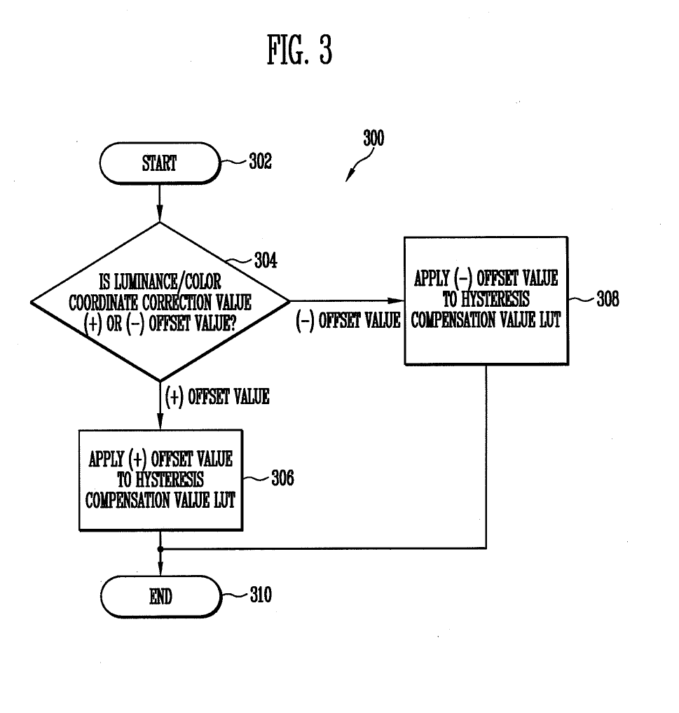

The detailed configuration and operation of the data compensator 50 of some embodiments will be described in detail with reference to FIGS. 2 and 3.

FIG. 2 is a configuration view illustrating an example of a data compensator shown in FIG. 1. FIG. 3 is a flowchart illustrating an example of a method of calculating a final data compensation value by applying a luminance/color coordinate correction value to a hysteresis compensation value lookup table.

Referring to FIG. 2, the data compensator 50 according to this embodiment calculates a data compensation value using a hysteresis compensation value and a luminance/color coordinate compensation value, and outputs compensation data DATA′ by adjusting the current data DATA using the data compensation value.

The data compensator 50 includes a storage unit 52, a hysteresis compensation value lookup table (hereinafter, referred to as a hysteresis compensation value LUT) 54, a compensation value calculator 56 and an operator 58.

The storage unit 52 is used to temporarily store a previous data signal. If the current data DATA is input, the storage unit 52 outputs the temporarily stored previous data to the compensation value calculator 56 according to a control signal supplied from the timing controller 40, and temporarily stores the input as current data DATA.

The hysteresis compensation value look up table (LUT) 54 is an LUT in which a hysteresis compensation value corresponding to the compared result of the current data DATA and the previous data is stored. For example, a hysteresis compensation value corresponding to the difference between the current data DATA and the previous data may be stored in the hysteresis compensation value LUT 54.

The compensation value calculator 56 receives the previous data together with the current data DATA, and extracts a hysteresis compensation value from the hysteresis compensation value LUT 54 by comparing the current data DATA and the previous data signal. For example, the compensation value calculator 56 may calculate a difference between the current data DATA and the previous data and extract a hysteresis compensation value from the hysteresis compensation value calculator LUT 54, which corresponds to the difference between the current data DATA and the previous data. The compensation value calculator 56 may include a subtractor for calculating a difference between the current data DATA and the previous data.

The compensation value calculator 56 receives a luminance/color coordinate correction value 55, which has been previously determined during the luminance correction process of the panel. The compensation value calculator 56 uses luminance/color coordinate correction value 55 along with the hysteresis compensation value, thereby calculating the data compensation value. For example, the compensation value calculator 56 may calculate the data compensation value by summing the hysteresis compensation value and the luminance/color coordinate compensation value 55. In some embodiments, the compensation value calculator 56 may include an adder for adding up the hysteresis compensation value and the luminance/color coordinate compensation value. However, the compensation value calculator 56 is not necessarily limited to the addition when calculating the data compensation value using the hysteresis compensation value and the luminance/color coordinate compensation value 55. For example, the compensation value calculator 56 may calculate the data compensation value by applying an additional offset value to the hysteresis compensation value in proportion to the luminance/color coordinate compensation value 55.

In some embodiments, the compensation value calculator 56 predicts a process tolerance of the panel with reference to the luminance/color coordinate compensation value 55, and adjusts the hysteresis compensation value so that the hysteresis compensation is more effective by using the process tolerance of the panel.

As shown in FIG. 3, the process 300 starts at block 302. The process next moves to decision state 304, wherein the compensation value calculator 56 determines whether the luminance/color coordinate compensation value is a (+) or (−) offset value and apply the additional offset value to hysteresis compensation value extracted from the hysteresis compensation value LUT 54 according to the decided result. If the compensation value calculator 56 determines the luminance/color coordinate correction value is a (+) offset value, the process 300 moves to block 306, wherein the (+) offset value is applied to the hysteresis compensation value extracted from the hysteresis compensation value LUT 54. If the compensation value calculator 56 determines the luminance/color coordinate correction value is a (−) offset value, the process 300 moves to block 308, wherein the (−) offset value is applied to the hysteresis compensation value extracted from the hysteresis compensation value LUT 54.

The offset range of the luminance/color coordinate compensation value may be determined based on a center value among the luminance/color coordinate compensation values. Referring back to FIG. 2, for example, when the luminance/color coordinate compensation value 55 has a value of 8 bits in a range of 00000000 to 11111111, the center value may be set to 00001111, and the (+) or (−) offset direction may be determined based on the center value.

In some embodiments, in the calculating of the data compensation value, if the luminance/color coordinate compensation value is within the (+) offset range, the (+) offset value is applied to the hysteresis compensation value. If the luminance/color coordinate compensation value is within the (−) offset range, the (−) offset value is applied to the hysteresis compensation value. However, the present development is not limited thereto.

The method of calculating the data compensation value may be modified based on the design, such as the type of a transistor, or other components. For example, in a case where a relatively low driving current flows with the same data voltage due to a high threshold voltage of the transistor, and therefore, luminance decreases, the offset value may be applied so that a higher driving current can flow through the transistor. In a case where a relatively high driving current flows with the same data voltage due to a low threshold voltage of the transistor, and therefore, luminance increases, the offset value may be applied so that a lower driving current can flow through the transistor.

Next, the operator 58 outputs compensation data DATA′ by operating the current data DATA and the data compensation value. In some embodiments, for example, the operator 58 may be set as an adder for adding up the current data DATA and the data compensation value.

A driving method of the OLED display device, in which hysteresis is compensated using the data compensator according to this embodiment, will be described. The driving method includes storing previous data in the storage unit 52, comparing the previous data and current data DATA and extracting a hysteresis compensation value corresponding to the compared result, calculating data compensation value by operating the hysteresis compensation value with a luminance/color coordinate compensation value 55, generating and outputting compensation data DATA′ obtained by changing the current data DATA through application of the data compensation value, generating a data signal by providing the compensation data DATA′ to the data driver 20, and supplying the data signal to the pixels.

Specifically, the hysteresis compensation value may be obtained by calculating a difference between the previous data and the current data DATA and extracting a hysteresis compensation value corresponding to the difference from the hysteresis compensation value LUT 54 in which the hysteresis compensation value is stored.

The data compensation value may be obtained by adding the hysteresis compensation value and the luminance/color coordinate compensation value 55 or by applying an additional offset value, either (+) or (−), to the hysteresis compensation value in proportion to the luminance/color coordinate compensation value 55. In this case, the additional offset value may be set by detecting the range and degree of the luminance/color coordinate compensation value, based on the reference value the luminance/color coordinate compensation value.

Meanwhile, the compensation data DATA′ is generated using the data compensation value and the current data DATA. For example, the compensation data DATA′ may be generated by adding up the data compensation value and the current data DATA. The compensation data DATA′ is used to generate an actual data signal, and thus the OLED display device displays an image corresponding to the compensation data DATA′.

While the present development has been described in connection with certain exemplary embodiments, it is to be understood that the development is not limited to the disclosed embodiments, but, on the contrary, is intended to cover various modifications and equivalent arrangements included within the spirit and scope of the appended claims, and equivalents thereof.

What is claimed is:

1. An organic light emitting diode display device, comprising:
a pixel unit having a plurality of pixels positioned at the intersections of scan lines and data lines;
a scan driver configured to supply a scan signal to the scan lines;
a data driver configured to supply a data signal to the data lines;
a data compensator configured to determine a hysteresis compensation value by comparing a present and a previous data signal, and to output a compensation data value using the hysteresis compensation value and a luminance/color coordinate compensation value; and
a timing controller configured to supply a control signal to the scan driver, the data driver, and the data compensator, and to control providing the data driver with the compensation data value supplied from the data compensator.

2. The organic light emitting diode display device according to claim 1, wherein the data compensator is configured to calculate a data compensation value using the hysteresis compensation value and the luminance/color coordinate compensation value, and configured to outputs a compensation data signal by performing an operation on the current data signal using the data compensation value.

3. The organic light emitting diode display device according to claim 1, wherein the data compensator comprises:
a storage unit configured to store the previous data signal;
a lookup table in which a plurality of hysteresis compensation values corresponding to potential differences between the current and previous data signals are stored;
a compensation value calculator configured to determine the hysteresis compensation value from the lookup table which corresponds to the difference between the current and previous data signals, and configured to calculate a data compensation value using the hysteresis compensation value and the luminance/color coordinate compensation value; and
an operator configured to output the compensation data signal by performing an operation on the current data signal using the data compensation value.

4. The organic light emitting diode display device according to claim 3, wherein the compensation value calculator includes at least one of a subtractor configured to calculate the difference between the current and previous data signals, and an adder configured to add the hysteresis compensation value and the luminance/color coordinate compensation value.

5. The organic light emitting diode display device according to claim 3, wherein the compensation value calculator is configured to apply a positive offset value to the extracted hysteresis compensation value when the luminance/color coordinate compensation value is within a positive offset range based on a reference value, and configured to apply a negative offset value to the extracted hysteresis compensation value when the luminance/color coordinate compensation value is within a negative offset range based on the reference value.

6. The organic light emitting diode display device according to claim 3, wherein the operator is an adder configured to add the current data signal and the data compensation value.

7. A method of driving an organic light emitting diode display device, comprising:
storing a previous data signal;
comparing the previous data signal with a current data signal and determining a hysteresis compensation value corresponding to the compared result;
calculating a data compensation value using the hysteresis compensation value and a luminance/color coordinate compensation value;
generating and outputting a compensation data signal obtained by changing the current data signal using the data compensation value; and
generating a data signal corresponding to the compensation data signal and supplying the data signal to pixels.

8. The driving method according to claim 7, wherein determining the hysteresis compensation value comprises:
calculating a difference between the previous and current data signals; and
extracting a hysteresis compensation value from a lookup table in which a plurality of hysteresis compensation values are stored, wherein the hysteresis compensation values correspond to potential differences between the present and previous data signals.

9. The driving method according to claim 7, wherein, calculating the data compensation value, comprises adding the hysteresis compensation value and the luminance/color coordinate compensation value.

10. The driving method according to claim 7, wherein generating the compensation data signal comprises adding the data compensation value and the current data signal.

11. The driving method according to claim 7, wherein calculating the data compensation value comprises applying a positive offset value to the extracted hysteresis compensation value when the luminance/color coordinate compensation value is within a positive offset range based on a reference value, and applying a negative offset value to the extracted hysteresis compensation value when the luminance/color coordinate compensation value is within a negative offset range based on the reference value.
